(19) United States
(12) Patent Application Publication
(10) Pub. No.: US 2012/0280801 A1
(43) Pub. Date: Nov. 8, 2012

(54) CONTROLLED DEVICE, DEVICE CONTROL SYSTEM, DEVICE CONTROL PROGRAM AND DEVICE CONTROL METHOD

(75) Inventor: Fumitake Muratsu, Tokyo (JP)

(73) Assignee: NEC CORPORATION, Minato-ku, Tokyo (JP)

(21) Appl. No.: 13/521,660

(22) PCT Filed: Feb. 17, 2011
(86) PCT No.: PCT/JP2011/054057

§ 371 Date: Jul. 11, 2012

(30) Foreign Application Priority Data
Feb. 22, 2010 (JP) 2010-035648

(51) Int. Cl. G08C 17/02

(52) U.S. Cl. 340/12.5

(57) ABSTRACT

A user roaming between networks faces an ease of use problem when controlling devices connecting to a network by means of the user's controller. The disclosed controlled device, which is connected to an access point capable of wireless communication with a management terminal located in the vicinity, is provided with: a specific function unit which inputs a specific command and performs a specific operation depending on the specific command; and an analysis unit which receives from a management terminal capable of communication with an access point a command (a general use command) not specifying the controlled device and not depending on the controlled device, and which, if the specific command corresponding to the general use command exists, outputs the specific command to the specific function unit and a response to the management terminal, and, if no specific command corresponding to the general use command exists, ignores the general use command.

### TECHNICAL FIELD

The present invention relates to a controlled device, a device control system, a device control program and a device control method.

### BACKGROUND ART

Patent document 1 discloses a center apparatus which performs simultaneous multiple address communication to terminal transmitters and thereby gives them an instruction to start a medical examination.

Patent document 2 discloses a server which stores control request commands based on the user's control instructions. Receiving an inquiry from a local control apparatus, the server sends a control request command targeted at an apparatus under the control of the local control apparatus, from among the stored control request commands.

Patent document 3 discloses a server which receives an input for operating a home electric appliance from each user via a network and remotely operates home electric appliances of different manufacturers. The server functions as a site where interfaces for operating home electric appliances of different manufacturers are unified into one interface.
[Patent Document 1] Japanese Patent Application Laid-Open No. 1993-328449
[Patent Document 2] Japanese Patent Application Laid-Open No. 2009-16890
[Patent Document 3] Japanese Patent Application Laid-Open No. 2003-209892

### DISCLOSURE OF INVENTION

### Technical Problem

When a user roaming among a plurality of networks controls devices connected to the respective networks by the use of a controller he carries, he usually has inconvenience in the use. The user (or the controller) needs to obtain capability information for a controlled device which is connected to the network the user belongs after his movement, and then to input, to a device having a desired function, an instruction which are specific to the device.

The user of the center apparatus described in patent document 1 needs to store functions of a terminal transmitter and a command format of an instruction for starting, in the apparatus in advance. The user of the server described in patent document 2 needs to store functions an apparatus under the control of a local control apparatus can execute, and a format of corresponding control commands, in the server in advance. The user of the server of patent document 3 needs to grasp capability information for home electronic appliances under the control of the server, and then to designate the server and give it an operation instruction.

The objective of the present invention is, for solving the problems described above, to provide a controlled device, a device control system, a device control program and a device control method.

### Solution to Problem

A controlled device of one exemplary embodiment of the present invention is connected to an access point capable of communicating wirelessly with a management terminal existing in the vicinity, and comprises: a specific function means which, receiving an input of a specific command, performs a specific operation according to the specific command; and an analysis means which receives a general use command, which is a command neither specifying or depending on the controlled device, from the management terminal capable of communicating with the access point, and if there exists the specific command corresponding to the general use command, outputs the specific command and a response respectively to the specific function means and the management terminal, and if there does not exist the specific command corresponding to the general use command, ignores the general use command.

A program for controlling a controlled device of one exemplary embodiment of the present invention causes a computer, which is connected to an access point capable of communicating wirelessly with a management terminal existing in the vicinity, to execute: a specific function process of receiving an input of a specific command and performing a specific operation according to the specific command; and an analysis process of receiving a general use command, which is a command neither specifying or depending on the program for controlling the controlled device, from the management terminal capable of communicating with the access point, and if there exists the specific command corresponding to the general use command, generating the specific command for the above-mentioned specific function process and outputting a response to the management terminal, and if there does not exist the specific command corresponding to the general use command, ignoring the general use command.

A method for controlling a controlled device of one exemplary embodiment of the present invention comprises: a specific function step wherein a controlled device connected to an access point capable of communicating wirelessly with a management terminal existing in the vicinity receives an input of a specific command, and performs a specific operation according to the specific command; and an analysis step wherein the controlled device receives a general use command, which is a command neither specifying or depending on a method for controlling the controlled device from the management terminal capable of communicating with the access point, and if there exists the specific command corresponding to the general use command, generates the specific command for the above-mentioned specific function step and outputs a response to the management terminal, and if there does not exist the specific command corresponding to the general use command, ignores the general use command.

### Advantageous Effects of Invention

A user roaming among a plurality of networks can easily control devices connected to the respective networks by the use of a controller he carries.

### BRIEF DESCRIPTION OF THE DRAWINGS

FIG. 1 Shown is an example of a configuration of a device control system 10 of the present exemplary embodiment.

FIG. 2 Shown is the first example of a configuration of a controlled device 20.

FIG. 3 Shown is the second example of a configuration of a controlled device 20.

FIG. 4 Shown is an example of a configuration for each of a controlled device 20 and a management terminal 40.

FIG. 5 Shown is data stored in a command pattern storage unit 24 of a controlled device 20.

FIG. 6 Shown is an example of data stored in a message board 43 of a management terminal 40.

FIG. 7 Shown is an operational flowchart of an analysis unit 23.

FIG. 8 Shown is an operational flowchart of an information providing unit 22.

FIG. 9 Shown is an operational flowchart of a control unit 42 of a management terminal 40.

FIG. 10 Shown is an example of a configuration of a local network 11 of the second exemplary embodiment.

FIG. 11 Shown is a configuration of proposal information 90.

FIG. 12 Shown is data stored in a command pattern storage unit 24 of the second exemplary embodiment.

FIG. 13 Shown is a part of an operational flowchart of the analysis unit 23 of the second exemplary embodiment.

FIG. 14 Sown is a diagram showing the third exemplary embodiment of a controlled device 20.

### DESCRIPTION OF EMBODIMENTS

### First Exemplary Embodiment

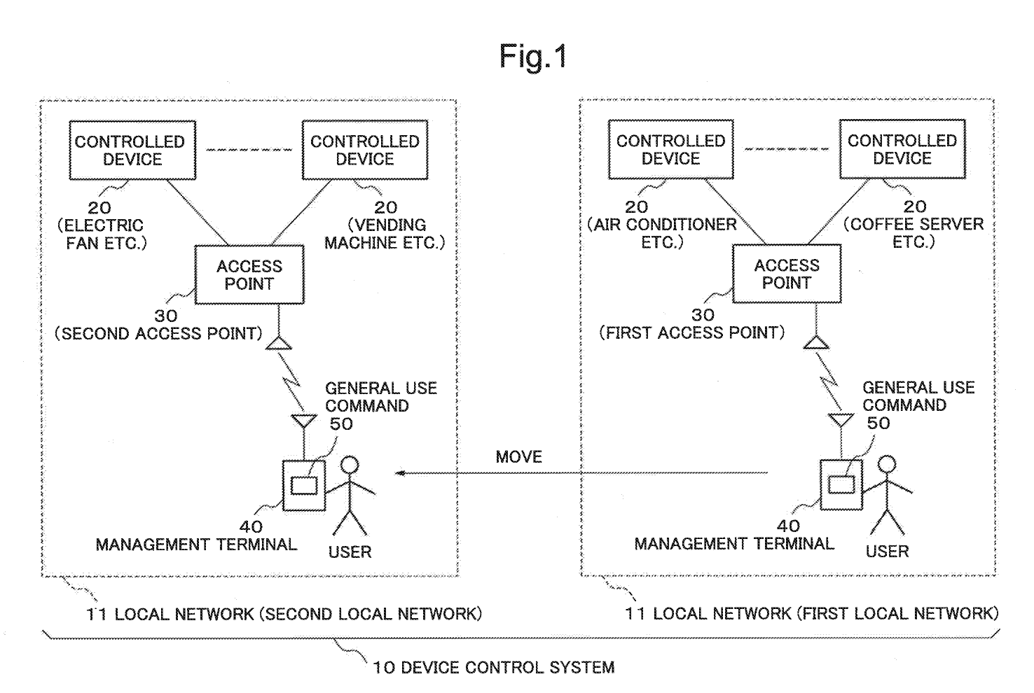

FIG. 1 shows an example of a configuration of a device control system 10 of the present exemplary embodiment. The device control system 10 consists of a plurality of local networks 11. Each local network 11 consists of one access point 30 and one or more controlled devices 20 connected to the access point 30 by wire or wireless. Each local network 11 may include another access point 30 connected to the above-described access point 30. Each local network 11 is a LAN (Local Area Network) or the like established at home, office, a Wi-Fi spot or the like.

The device control system 10 includes one or more portable-type management terminals 40 carried by the users. Each management terminal 40 can communicate wirelessly with an access point 30 existing in the vicinity.

Here, the vicinity indicates an area where a management terminal 40 and an access point 30 can communicate wirelessly with each other, and the spatial size of the area is determined depending on a wireless communication method and the like. The vicinity does not necessarily mean a “narrow” area. Because each access point 30 belonging to a local network 11 is located away from other access points 30 belonging to other local networks 11, each management terminal 40 cannot communicate simultaneously with access points 30 belonging to different ones of the plurality of local networks 11. Wireless LAN, Bluetooth, infrared and the like are used as a wireless communication method. A management terminal 40 stores general use commands 50 inside.

A controlled device 20 reads, via the access point 30 it is connected to, a general use command 50 from the management terminal 40 existing in the vicinity of the access point 30.

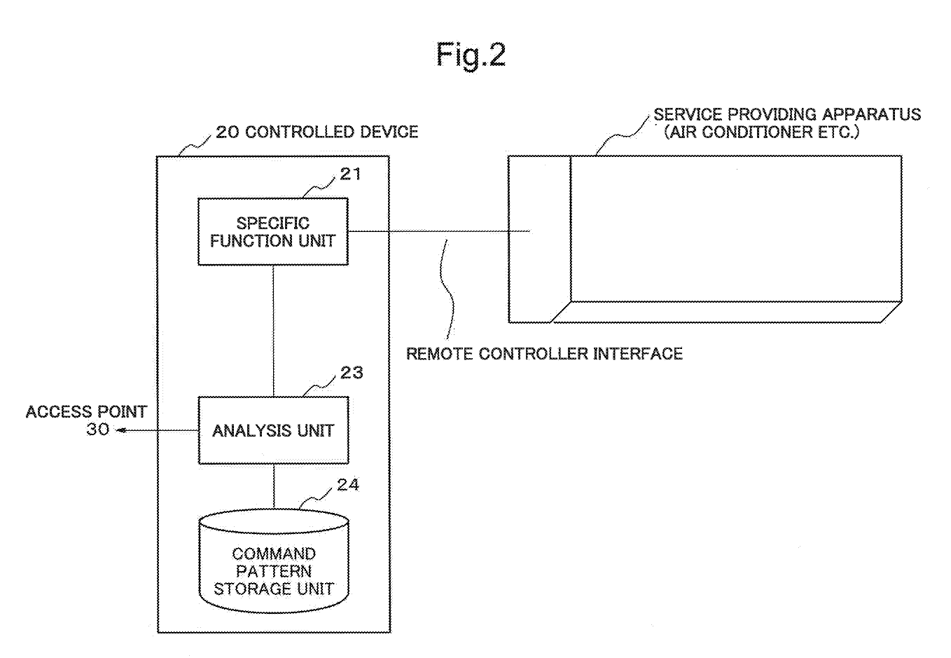

FIG. 2 shows the first example of a configuration of a controlled device 20. The controlled device 20 is an apparatus which receives an input of a general use command 50, and according to the command, performs operation (power on/off, temperature setting and the like) of a service providing apparatus such as an air conditioner. For example, the controlled device 20 is configured as an apparatus separated from an air conditioner or the like, and they are connected with each other by a remote control interface such as of infrared communication, as shown in FIG. 2. The controlled device 20 may be built in as a part of an air conditioner or the like.

The service providing apparatus is an electronically controllable apparatus such as a television, a video recorder and a vending machine. Hereafter, a controlled device 20 may be referred to by the name of a service providing apparatus under its control. For example, the controlled device 20 in FIG. 2 may be referred to as an air conditioner.

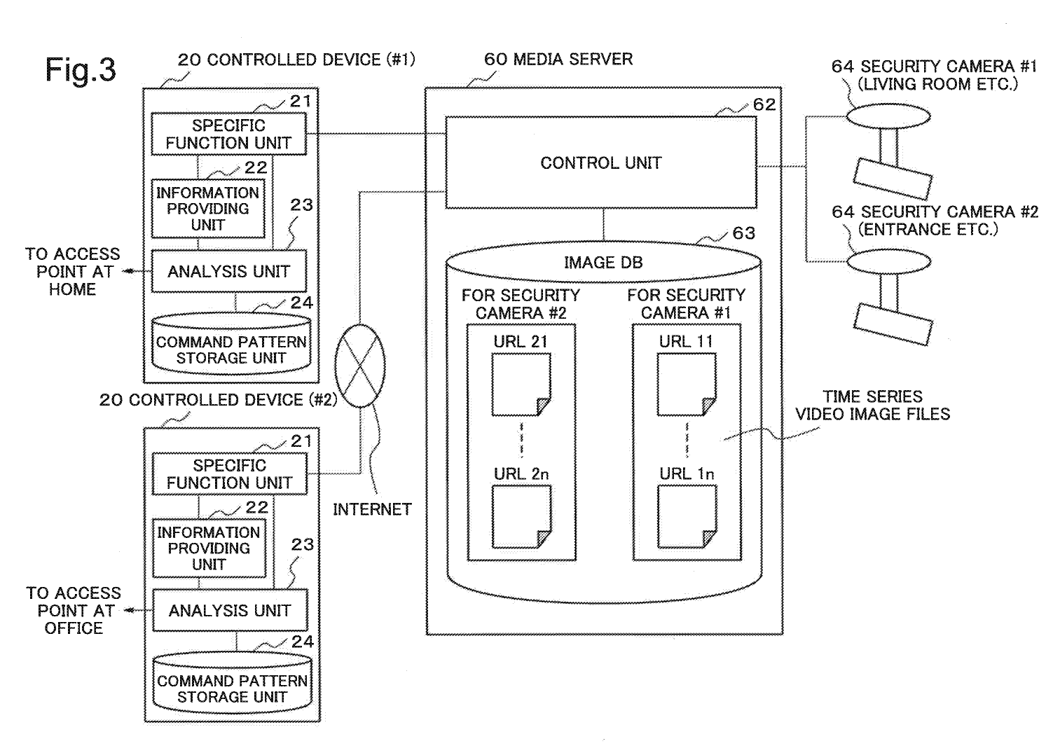

FIG. 3 shows the second example of a configuration of a controlled device 20. Each of the controlled devices 20 in the diagram receives an input of a general use command 50 and, according to the command, performs operation of a media server 60 installed at the user's home or the like.

A control unit 62 of the media server 60 records into an image DB 63 video images captured by one or more security cameras 64 installed in the living room and the like. For example, the control unit 62 creates a time series video image for every 30 minutes with respect to each security camera 64, and stores it in the image DB 63.

When receiving an input of an instruction of high resolution display from the controlled devices 20, for example, the control unit 62 creates and sends back a response including link information to each video image file. When receiving an input of an instruction of low resolution display, for example, the control unit 62 creates a low resolution version of each video image file, and creates and sends back a response including link information to the low resolution image files.

The responses are generated by the use of a description language such as HTML (HyperText Markup Language). The link information is described in the form of a URL (Uniform Resource Locator) or the like. When receiving an input of the URL which is link information, the control unit 62 outputs a video image corresponding to the URL.

One of the controlled devices 20 (#1) is installed, for example, in the vicinity of the media server 60 (at home or the like), and is directly connected to the media server 60. When the controlled device (#1) receives an input of a general use command 50 “show me the situation of my home” from a management terminal 40 via an access point 30 such as at home, it outputs an instruction of high resolution display described above, as a specific command, to the media server 60.

The other one of the controlled devices 20 (#2) is installed, for example, away from the media server 60 (at office or the like), and is connected to the media server 60 via the internet. When the controlled device (#2) receives an input of the general use command 50 “show me the situation of my home” from the management terminal 40 via an access point 30 such as at office, it outputs an instruction of low resolution display described above, as a specific command, to the media server 60.

The controlled devices 20 (#1 and #2) may be built in as part of the media server 60. The media server 60 may include other controlled devices 20 (#3 and the like). In this case, a plurality of controlled devices 20 may share one hardware device. A specific command of each controlled device 20 is determined, for example, on the basis of a parameter which is set according to an access point 30 to which the controlled device 20 is connected.

Here, it is not necessary that the controlled devices 20 (#1 and #2) both exist.

The first specific example of a configuration and operation of the device control system 10 is as follows (refer to FIG. 1 and the like). An air conditioner and an electric fan with a temperature sensor are connected, as controlled devices 20, respectively to an access point 30 of the first local network 11 and to an access point 30 of the second local network 11. A management terminal 40 stores a general use command 50 “control the room temperature at 25 degrees C.”.

When the user carrying the management terminal 40 is present in the vicinity of the first access point (belongs to the first local network 11), the air conditioner having read the command starts operation with a target temperature set at 25 degrees C. When the user has moved to the vicinity of the second access point (belongs to the second local network 11), the electric fan with a temperature sensor having read the command starts blowing if the room temperature is higher than 25 degrees C.

The second specific example of a configuration and operation of the device control system 10 is as follows. A coffee server and a vending machine with an inventory management function are connected, as controlled devices 20, respectively to an access point 30 of the first local network 11 and to an access point 30 of the second local network 11. A management terminal 40 stores a general use command 50 “want to drink coffee”.

When the user carrying the management terminal 40 has moved from a spot outside both of the two local networks 11 to the vicinity of the first access point 30, the coffee server having read the command starts coffee brewing operation and also sends a message “making coffee” to the management terminal 40. When the user has moved to the vicinity of the second access point 30, the vending machine having read the command sends a message “coffee is on sale” to the management terminal 40.

The third specific example of a configuration and operation of the device control system 10 is as follows. Controlled devices 20 are configured as in FIG. 3. A management terminal 40 stores a general use command 50 “show me the situation of my home”.

When the user carrying the management terminal 40 is present in the vicinity of an access point 30 such as at home, a media server 60 under the control of a controlled device 20 (#1) having read the command outputs link information for a high resolution image. When the user has moved to the vicinity of an access point 30 such as at office, the media server 60 under the control of a controlled device 20 (#2) having read the command generates a low resolution image file and outputs its link information.

As has been described above, in many cases, types of controlled devices 20 belonging to respective local networks 11 are different from one local network 11 to another. Even in such cases, it becomes possible for the user moving into a new local network 11, without knowing in advance how and which of controlled devices 20 belonging to the local network 11 meets his request, to send a vague request to the controlled devices 20.

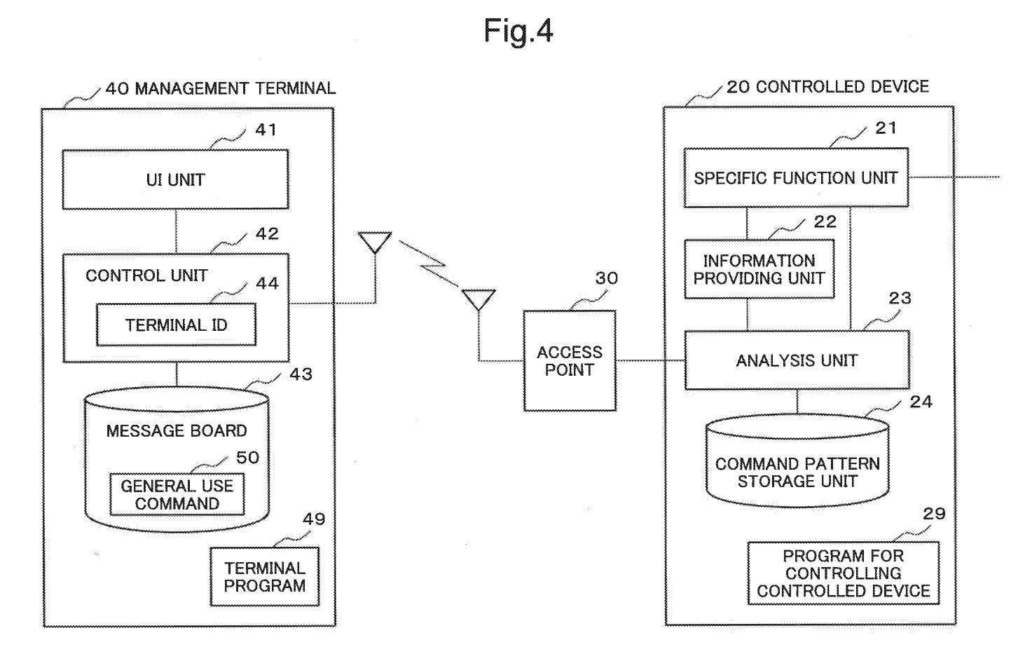

FIG. 4 shows an example of a configuration of a controlled device 20 and that of a management terminal 40. The controlled device 20 includes a specific function unit 21, an analysis unit 23 and a command pattern storage unit 24. The controlled device 20 may further include an information providing unit 22.

The specific function unit 21 performs operations specific to a type of each controlled device 20. The unit performs, for example, operations such as of raising/lowering the room temperature by controlling a service providing apparatus, which is an air conditioner, connected to it. Alternatively, the unit performs, for example, operations of starting/stopping blowing by controlling an electric fan with a temperature sensor.

The analysis unit 23 reads a general use command 50 from the management terminal 40 via an access point 30, determines a specific operation to realize the general use command 50, and outputs an instruction (specific command) to cause the specific function unit 21 to execute the specific operation. The specific command means a set of one or more request signals or request messages to cause the specific function unit 21 to execute a predetermined specific operation, and it is not necessarily described as one unified command.

Here, the general use command 50 is a command in a format not depending on a controlled device 20. That is, receiving an input of an identical general use command 50, controlled devices 20 whose types are different from each other may execute respective specific operations which are different from each other.

In the device control system 10 in FIG. 1, each local network 11 may include any one of a plurality of controlled devices 20 which execute respective specific operations different from each other with respect to an identical general use command 50. For example, the first local network 11 includes an air conditioner, and the second local network 11 includes an electric fan with a temperature sensor.

When a specific operation corresponding to the inputted general use command 50 is not defined in it and a controlled device 20 to execute the general use command 50 is not specified, each of such controlled devices 20 ignores the general use command 50. That is, such controlled devices 20 do not either perform a specific operation or make a response (error message output or the like) with respect to the general use command 50. The command pattern storage unit 24 defines a specific operation corresponding to a general use command 50. The command pattern storage unit 24 is a storage device such as a memory or a disk. The command pattern storage unit 24 may be a file server or the like which is placed outside the controlled device 20 and is connected to it via the internet or the like. Also, it may be a combination of the file server and a cache disk or the like.

The command pattern storage unit 24 needs not be present if the number of general use commands 50 to execute is small. The analysis unit 23 may store required information statically.

When link information, which was outputted by the specific function unit 21, is referred to by the management terminal 40 or the like, the information providing unit 22 outputs linked information. While the controlled devices 20 shown in FIG. 3 include the information providing unit 22, the controlled device 20 shown in FIG. 2 possibly does not include the information providing unit 22.

The specific function unit 21, the analysis unit 23 and the information providing unit 22 are realized as dedicated hardware apparatuses. The specific function unit 21, the analysis unit 23, or part of or whole of the information providing unit 22 may be realized by execution of a program for controlling a controlled device 29 by a processor of the controlled device 20 which is also a computer.

The management terminal 40 contains a UI unit 41 (User Interface), a control unit 42 and a message board 43. The UI unit 41 is an interface section with the user, which is a display device, a speaker, a set of entry keys or the like. The control unit 42 performs overall control of the management terminal 40 including control of update and display of the message board 43.

The control unit 42 can access a specific identifier of the management terminal 40 (terminal ID 44). The terminal ID 44 is, for example, an identifier contained in an SIM (Subscriber Identity Module) card of the management terminal 40. The terminal ID 44 may be a MAC address of the management terminal 40.

The message board 43 contains general use commands 50 or the like. The message board 43 is a storage device such as a memory or a disk.

The control unit 42 is realized as a dedicated hardware apparatus. Part of or whole of the control unit 42 may be realized by execution of a terminal program 49 by a processor of the management terminal 40 which is also a computer.

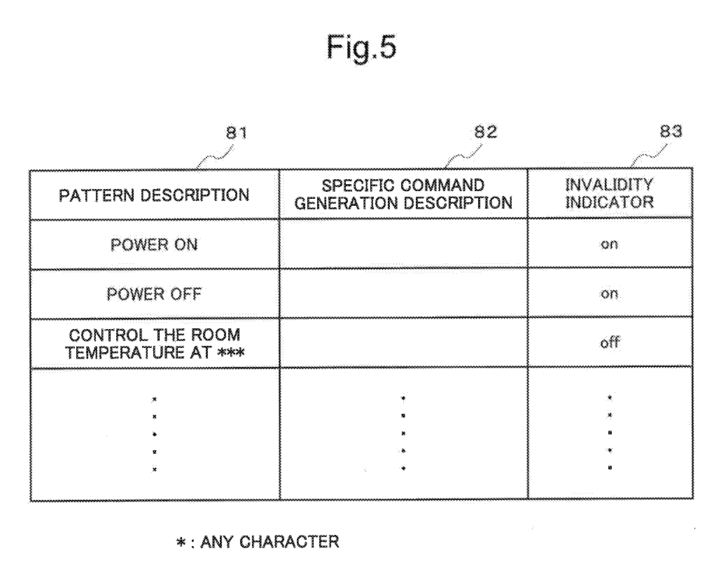

FIG. 5 shows data stored in the command pattern storage unit 24 of the controlled device 20. The command pattern storage unit 24 contains, corresponding to each general use command 50 for which a specific operation of the controlled device 20 is defined, a pattern description 81, a specific command generation description 82 and an invalidity indicator 83.

As a pattern description 81, for example, stored is a character string (“control the room temperature at ***”) or the like specifying each general use command 50. Here, * expresses any character. On detecting a character string specified by a pattern description 81 in a request character string (“control the room temperature at 25 degrees C.”) inputted from the management terminal 40, the analysis unit 23 recognizes the general use command 50 (“control the room temperature at ***”)

The specific command generation description 82 describes a procedure for detecting a parameter (“25 degrees C.”) or the like for performing the specific operation corresponding to the general use command 50 recognized from the above-mentioned character string, and giving the specific command to the specific function unit 21. The specific command generation description 82 may be either of a procedure description in a special scripting language or the like and an entry address description for a subroutine to execute the procedure.

The invalidity indicator 83 designates whether to invalidate (make it not executed again) the general use command 50 executed once (on) or not (off). For example, while a general use command 50 “control the room temperature at 25 degrees C.” is not invalidated even after being executed once, a general use command 50 “want to drink coffee” is invalidated once it is executed. The reason why an invalidity indicator 83 is designated for each general use command 50 is that, for example, in contrast to that a request “control the room temperature at 25 degrees C.” is a request to be continually satisfied, a request “want to drink coffee” is a request which vanishes once it is accomplished.

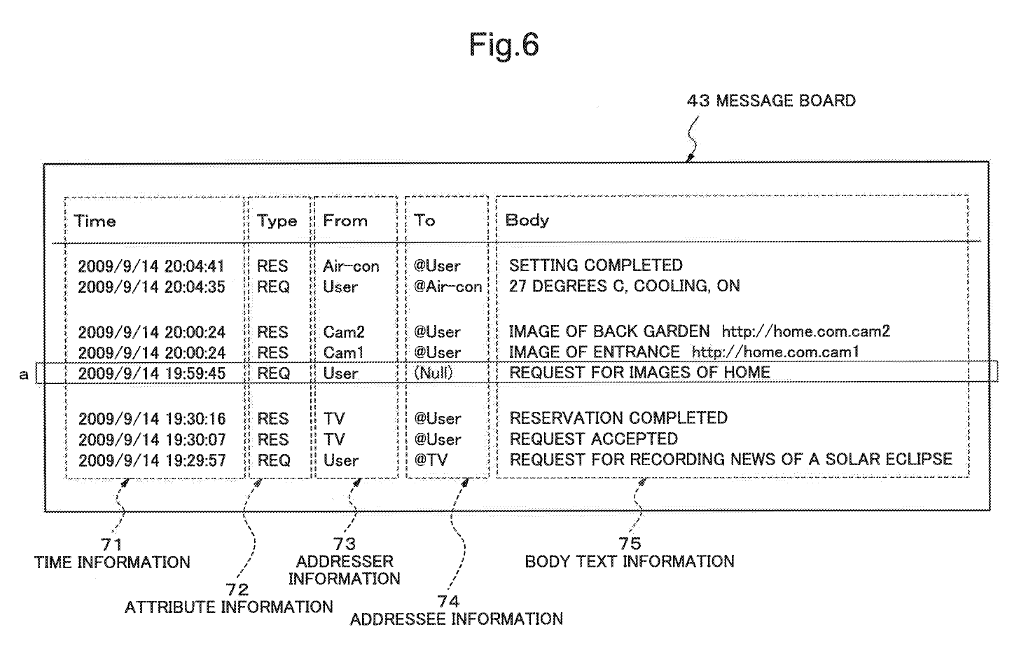

FIG. 6 shows an example of data stored in the message board 43 of the management terminal 40. The message board 43 contains attribute information 72, addresser information 73, addressee information 74 and body text information 75.

The message board 43 may further contain collateral information such as time information 71. The time information 71 represents a time of containing the body text information 75. The collateral information may further include information, not illustrated, which represents a place of containing the body text information.

The attribute information 72 represents whether the body text information 75 is a request character string (REQ) or a response character string (RES). The request character string is a character string which the control unit 42 received its input from the user via the UI unit 41 and stored in the message board 43. The request character string is described in accordance with a predetermined rule and includes a general use command 50 and related parameter information.

The response character string is a character string which the control unit 42 received its input from the controlled device 20 and stored in the message board 43. The response character string may include link information, which is, for example, a URL. The link information is used by the management terminal 40 to acquire information such as a video image from the controlled device 20.

The addresser information 73 represents a source from which the body text information 75 was acquired. In the case of a request character string, the addresser information 73 specifies the user. In the case of a response character string, the addresser information 73 specifies identification information (terminal ID 44 or information based on it) for a controlled device 20.

The addressee information 74 represents a destination of presenting the body text information 75. In the case of a request character string, the addressee information 74 specifies identification information for a controlled device 20 to be controlled. In the case of a response character string, the addressee information 74 specifies the user.

The body text information 75 stores a request character string or a response character string. In FIG. 6, a row indicated by “a” includes a request character string not specifying a controlled device 20. An addressee information 74 of the row indicated by “a” includes “Null” or the like.

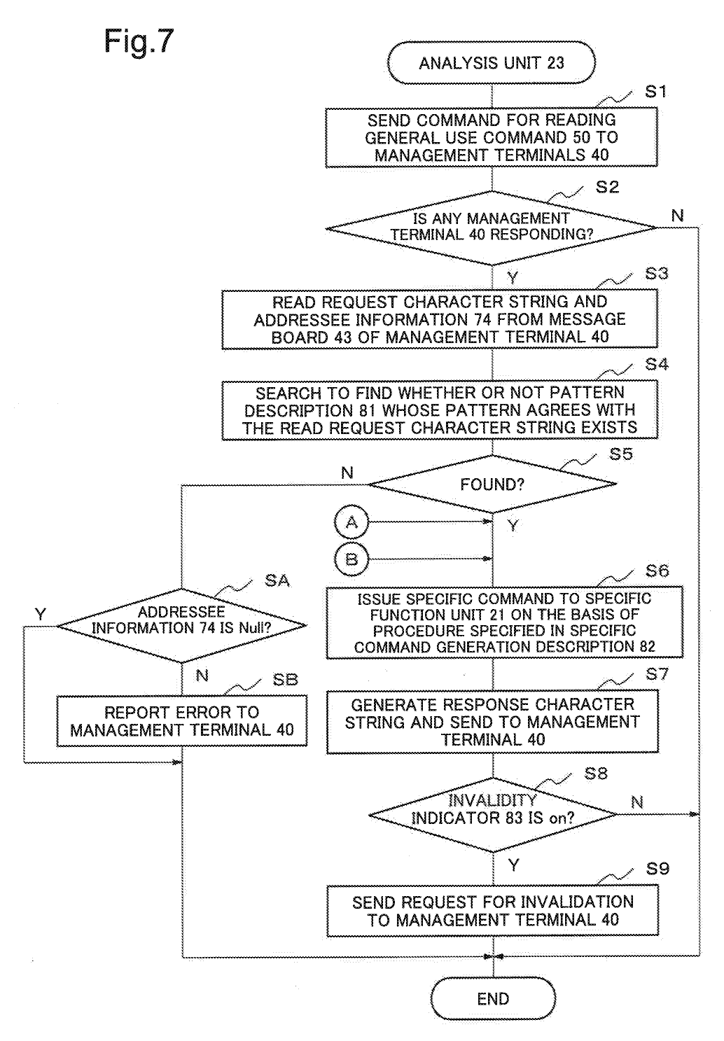

FIG. 7 is an operational flowchart of the analysis unit 23. The analysis unit 23 periodically multicasts a command for reading a general use command 50 to management terminals 40 via an access point 30 it is connected to (S1). When there exists a management terminal 40 responding to the above-mentioned request (Y at S2), the analysis unit 23 reads a request character string (body text information 75) and addressee information 74 from a message board 43 of the management terminal 40 (S3).

Here, instead of multicasting the command for reading a general use command 50, the analysis unit 23 may acquire from the access point 30 a terminal ID 44 of a management terminal 40 capable of communication, and send the command for reading a general use command 50 to the terminal ID 44.

Further, the analysis unit 23 may send the command for reading a general use command 50 being triggered by a notice from the access point 30 which has detected a management terminal 40 coming close to it.

Here, in the side of a management terminal 40 having received the command for reading a general use command 50, the control unit 42 reads a request character string from the message board 43 and sends it back to the analysis unit 23 of the controlled device 20.

The analysis unit 23 may read only the latest request character string. The analysis unit 23 may read one or more requests whose collateral information satisfies a predetermined condition. In the latter case, the analysis unit 23 sends the predetermined condition to the control unit 42 and causes it to select a request character string to be sent back to the analysis unit 23. The analysis unit 23 may cause the control unit 42 to send all request character strings, and select a request character string to be subjected to subsequent processes on the basis the predetermined condition.

The predetermined condition may be that time information 71 indicates a time within a predetermined range of time period from a predetermined time, and also may be that position information indicates a position within a predetermined area.

The analysis unit 23 searches the command pattern storage unit 24 to find whether or not there exists a pattern description 81 whose pattern agrees with that of the request character string it has read (S4). That is, the analysis unit 23 determines whether or not the request character string includes a general use command 50 for which a specific operation of the controlled device it belongs to is defined. When finding a pattern description 81 showing agreement (a general use command 50 for which a specific operation is defined) (Y at S5), the analysis unit 23 issues a specific command to the specific function unit 21 on the basis of the procedure specified in a specific command generation description 82 corresponding to the general use command 50 (S6).

Receiving a completion report of the specific operation from the specific function unit 21, the analysis unit 23 generates a response character string based on the report and sends it to the management terminal 40 (S7). When an invalidity indicator 83 corresponding to the general use command 50 is off (N at S8), the operation is ended, and when the indicator is on (Y at S8), a request for invalidation is sent to the management terminal 40 (S9) and then the operation is ended.

When any general use command 50 to execute cannot be found (N at S5), if the inputted addressee information 74 is Null (Y at SA), the analysis unit 23 ends the operation, and if not (N at SA), the analysis unit 23 reports an error to the management terminal 40 (SB) and then ends the operation.

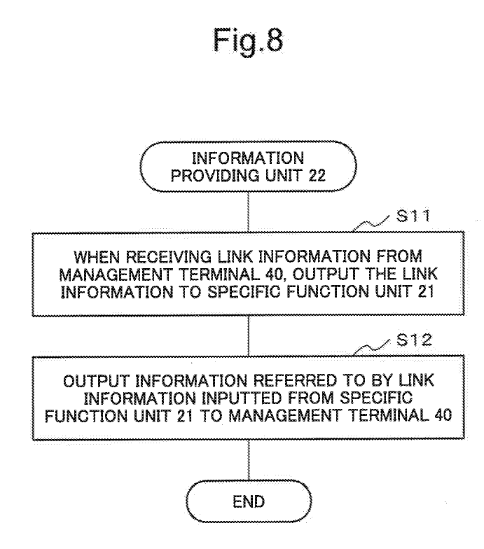

FIG. 8 is an operational flowchart of the information providing unit 22. When receiving link information from the management terminal 40, the information providing unit 22 outputs the link information to the specific function unit 21 (S11).

The link information is, for example, one of URLs of respective video image files stored in the video image DB 63, which were outputted by the media server 60, in response to a request for high resolution display, to the management terminal 40 via the controlled device 20 (#1). The management terminal 40 displays to the user the URLs outputted by the media server 60, and sends one of the URLs selected by the user to the controlled device 20 (#1).

The specific function unit 21 having received the URL from the information providing unit 22 forwards it to the media server 60, and the media server 60 outputs the contents of the video image file specified by the URL to the information providing unit 22 via the specific function unit 21.

The information providing unit 22 outputs information referred to by the link information inputted from the specific function unit 21, to the management terminal 40 (S12). The information referred to by the link information is, for example, video image information in the media server 60.

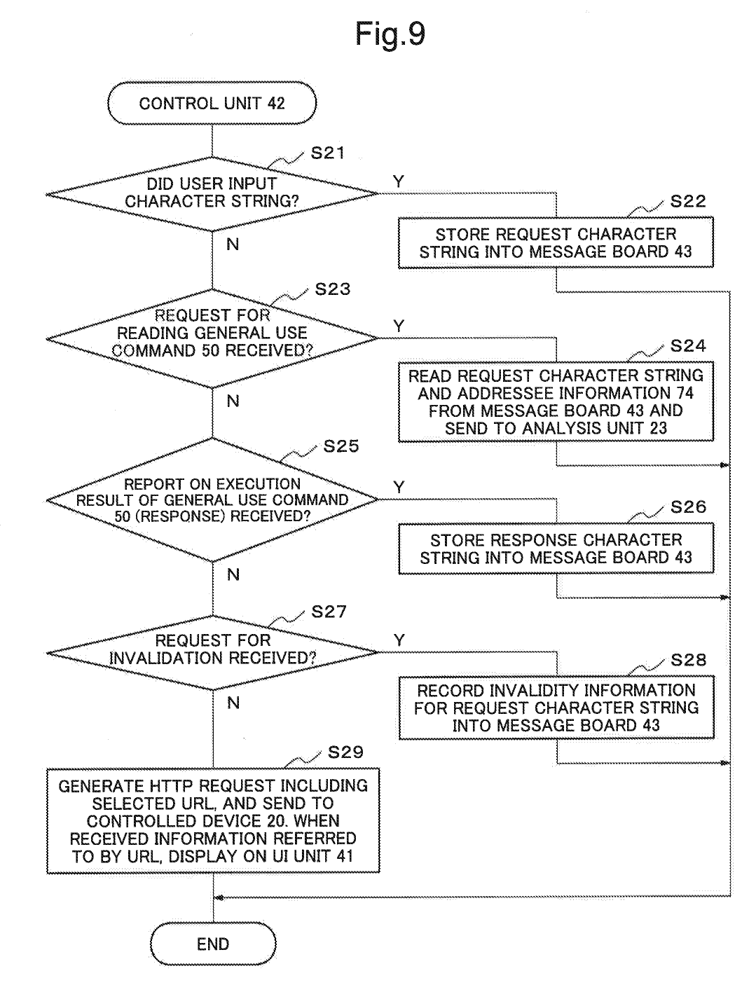

FIG. 9 is an operational flowchart of the control unit 42 of the management terminal 40. The control unit 42 is started up when information is received from the UI unit 41 or the access point 30.

When receiving a character string inputted by the user from the UI unit 41 (Y at S21), the control unit 42 stores each piece of information such as body text information 75 into the message board 43 (S22). Attribute information 72 stored there represents the fact that the body text information 75 is a request character string.

When receiving a request for reading a general use command 50 from the access point 30 (Y at S23), the control unit 42 reads a request character string (body text information 75) and addressee information 74 from the message board 43 and sends them to the analysis unit 23 (S24). At that time, the control unit 42 may perform selection of a sending target based on collateral information, on the basis of an instruction from the analysis unit 23 of the controlled device 20.

When receiving a report (response) on the execution result of the general use command 50 from the access point 30 (Y at S25), the control unit 42 stores each piece of information such as body text information 75 into the message board 43 (S26). Attribute information 72 stored there represents the fact that the body text information 75 is a response character string.

When receiving a request for invalidation from the access point 30 (Y at S27), the control unit 42 records invalidity information for the targeted request character string into the message board 43 (S28). For example, the control unit 42 additionally describes an invalidity flag, not illustrated in the drawing, in the request character string. Such request information accompanied by an invalidity flag is excluded from sending subjects at the time of receiving a command for reading a general use command 50 (S24).

When receiving another kind of input (N at S27), that is, when receiving an input of URL selection information from the UI unit 41, the control unit 42 generates an HTTP request including the selected URL and sends it to the controlled device 20. When receiving information referred to by the URL, the control unit 42 displays it on the UI unit 41 (S29).

The first advantageous effect the device control system 10 of the present exemplary embodiment has is that the user roaming among a plurality of local networks 11 can easily control, by the use of a management terminal 40 he carries, controlled devices 20 and service providing apparatuses which are connected to respective ones of the local networks 11.

The reason is that it becomes possible for the user to give a vague request (general use command 50) to a local network 11, without knowing in advance how and which controlled device 20 meets his request. Specifically, the reason is that controlled devices 20 each independently determines and executes an appropriate operation with respect to a general use command 50 or ignores the inputted general use command 50 (do not report a complicated error).

The second advantageous effect is capability of efficient communication. The reason is that each controlled device 20 reads a general use command 50 stored in the management terminal 40 and determines a specific operation. It is not necessary for the management terminal 40 to acquire, every when it comes to belong to a local network 11, capability information for controlled devices 20 connected to the local network 11.

The third advantageous effect is that it is possible to configure a local network 11 where controlled devices 20 according to the present invention coexist with usual devices. The reason is that each controlled device 20 reads a general use command 50 stored in the management terminal 40 and determines a specific operation. Accordingly, because the management terminal 40 does not perform broadcast or the like which is specific to the present invention, it does not induce a malfunction of the usual devices.

The fourth advantageous effect is capability of fine-tuned control of command execution. The reason is that an execution condition can be flexibly set according to a type of and collateral information of a command.

### Second Exemplary Embodiment

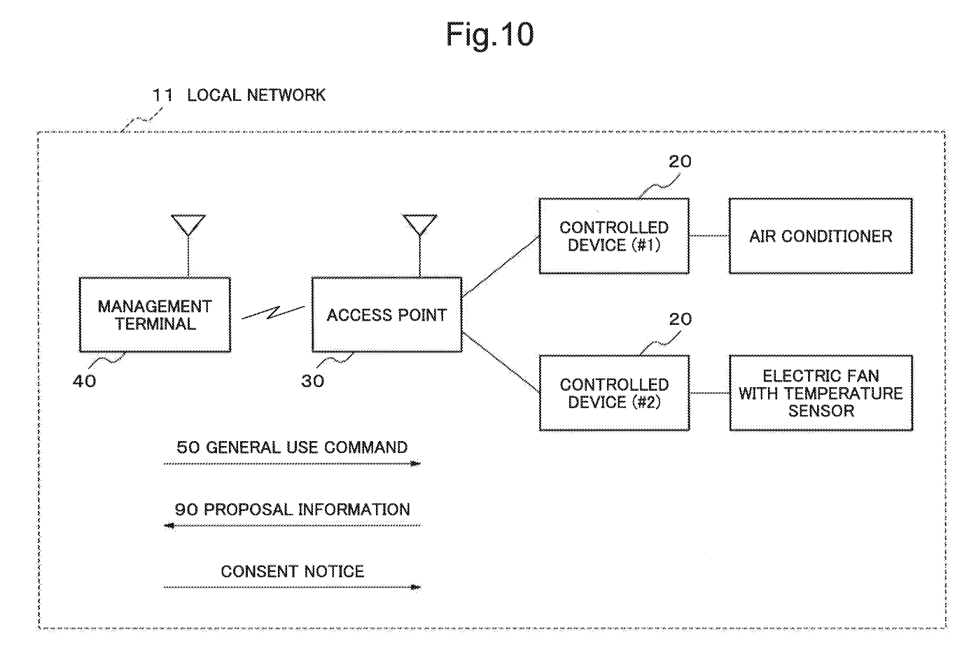

FIG. 10 shows an example of a configuration of a local network 11 of the second exemplary embodiment. In the diagram, a plurality of controlled devices 20 each capable of executing an identical general use command 50 are connected to one access point 30. Each of the plurality of controlled devices 20 executes a specific operation, which is different from that of the others, with respect to an identical general use command 50.

For example, a controlled device 20 (#1) is an air conditioner. Receiving an input of a general use command 50 “control the room temperature at 25 degrees C.” when the room temperature is at 28 degrees C., the controlled device starts cooling as a specific operation. A controlled device 20 (#2) is an electric fan with a temperature sensor. Receiving an input of the general use command 50, the controlled device starts rotating the fan as a specific operation.

When receiving an input of a general use command 50 to execute (such as to control the room temperature at 25 degrees C.), each controlled device 20 of the present exemplary embodiment presents to a management terminal 40 proposal information 90 including information specifying a specific operation (cooling, fan rotation or the like) corresponding to the general use command 50. If receiving a consent notice for the proposal information 90 from the management terminal 40, each controlled device 20 executes the specific operation.

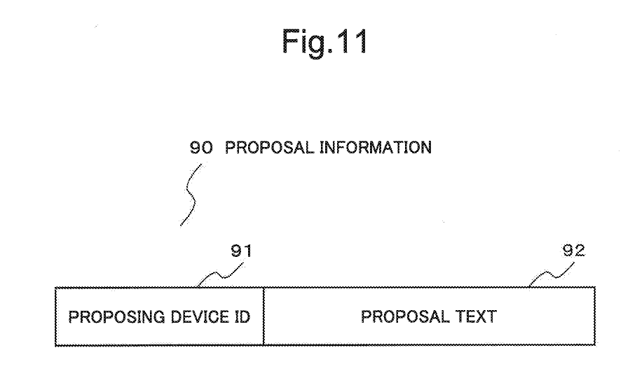

FIG. 11 shows a configuration of the proposal information 90. The proposal information 90 includes a proposing device ID 91 and proposal text 92. The proposing device ID 91 is an identifier (such as a MAC address) of the controlled device 20 sending the proposal information 90. The proposal text 92 is description text of a specific operation or the like of the controlled device 20 sending the proposal information 90.

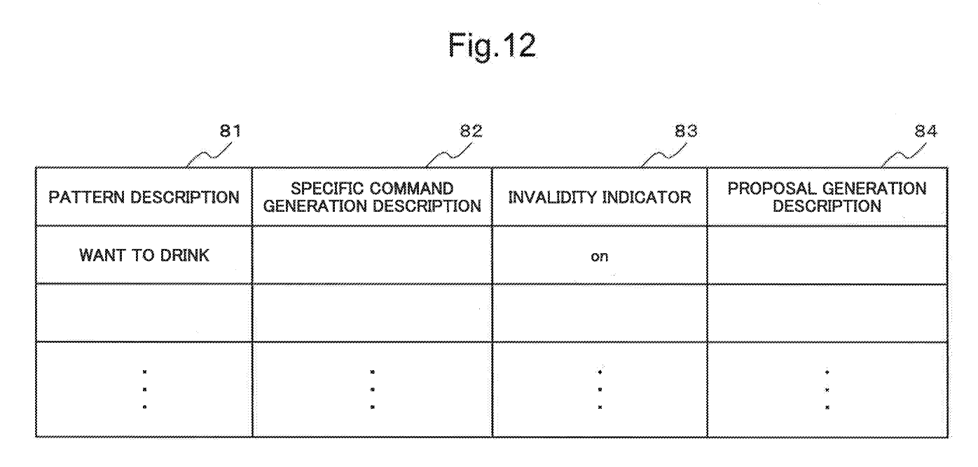

FIG. 12 shows data stored in a command pattern storage unit 24 of the second exemplary embodiment. The command pattern storage unit 24 of the present exemplary embodiment additionally stores a proposal generation description 84 corresponding to a general use command 50, compared with the first exemplary embodiment.

The proposal generation description 84 describes a procedure to detect a parameter or the like, in a request character string, for performing a specific operation corresponding to a general use command 50, and subsequently to generate proposal text 92 specifying a specific operation and the parameter or the like. The proposal generation description 84 may be a procedure description in a special scripting language or the like, and also may be an entry address description of a subroutine for executing the procedure.

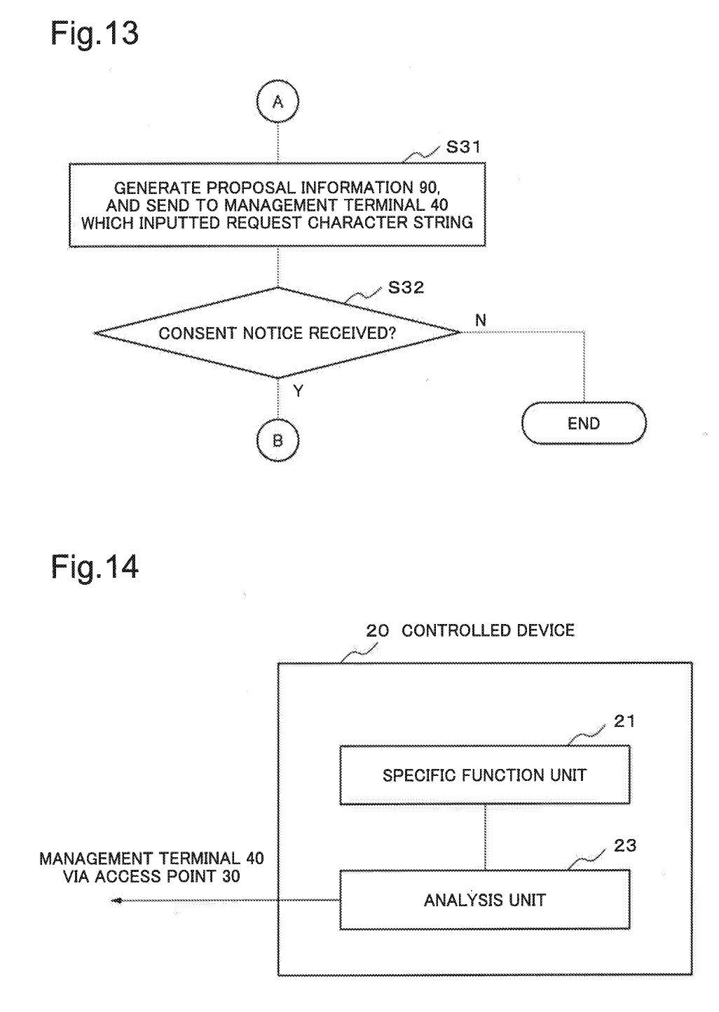

FIG. 13 is part of an operational flowchart of the analysis unit 23 of the second exemplary embodiment. The operational flowchart of the analysis unit 23 of the present exemplary embodiment equals to that obtained by inserting the operational flow of FIG. 13 between portions indicated by A and B of the operational flowchart in FIG. 7.

When finding a pattern description 81 agreeing with an inputted request character string (Y at S5 in FIG. 7), the analysis unit 23 generates proposal text 92 on the basis of the procedure specified by the proposal generation description 84 corresponding to the pattern description 81, and adds an identification information (proposing device ID 91) for the controlled device it belongs to. The analysis unit 23 sends the generated proposal information 90 to a management terminal 40 from which the request character string was inputted (S31).

The control unit 42 of the management terminal 40 receives proposal information 90 from one or more controlled devices 20 and displays it on the UI unit 41. From among the pieces of proposal information 90 displayed, the user selects one or more pieces on the basis a specific operation desired to be executed, and inputs the selection information from the UI unit 41 to the control unit 42.

The control unit 42 sends a consent notice to a controlled device 20 specified by a proposing device ID 91 which is included in the proposal information 90 selected by the user. The control unit 42 sends a denial notice to a controlled device 20 specified by a proposing device ID 91 which is included in the proposal information 90 not selected by the user.

When receiving the consent notice (Y at S32), the analysis unit 23 of the controlled device 20 issues a specific command to the specific function unit 21 (S6 in FIG. 7). When receiving a denial notice or not receiving any consent notice within a predetermined time period (N at S32), the analysis unit 23 ends the operation.

The advantageous effect of the device control system 10 of the present exemplary embodiment is that the user can control controlled devices 20 and service providing apparatuses, which are connected to respective local networks 11, easily and in a way they perform the optimum operations. It is because each controlled device 20 generates proposal information 90 and thereby permits the user to select a specific operation.

FIG. 14 is a diagram showing the third exemplary embodiment of a controlled device 20. The controlled device 20 is connected to an access point 30 capable of communicating with a management terminal 40 existing in the vicinity. The controlled device 20 comprises a specific function unit 21 and an analysis unit 23.

The specific function unit 21 receives an input of a specific command and performs a specific operation of the controlled device 20 according to the specific command. The analysis unit 23 receives a general use command 50 not specifying the controlled device 20 from the management terminal 40 capable of communicating with an access point 30, and if there exists a specific command corresponding to the general use command 50, outputs the specific command and a response respectively to the specific function unit 21 and to the management terminal 40. If there does not exist a specific command corresponding to the general use command 50, the analysis unit 23 ignores the general use command 50.

The advantageous effect of the controlled device 20 of the present exemplary embodiment is that the user roaming among a plurality of local networks 11 can easily control, by the use of a management terminal 40 he carries, controlled devices 20 connected to respective local networks 11. The reason is that it becomes possible for the user to give a vague request (general use command 50) to a local network 11, without knowing in advance how and which controlled device 20 meets his request. Specifically, the reason is that controlled devices 20 each independently determines and executes an appropriate operation with respect to the general use command 50 or ignores the inputted general use command 50.

Although the present invention has been described above with reference to exemplary embodiments (and examples), the present invention is not limited to the above-described exemplary embodiments (and examples). Various changes and modifications which are understood by those skilled in the art can be made in configurations and details of the present invention, within the scope of the present invention.

This application insists on priority based on Japanese Patent Application No. 2010-035648 filed on Feb. 22, 2010, the disclosure of which is incorporated herein in its entirety by reference.

### REFERENCE SIGNS LIST

10 device control system
11 local network
20 controlled device
21 specific function unit
22 information providing unit
23 analysis unit
24 command pattern storage unit
29 program for controlling a controlled device
30 access point
40 management terminal
41 UI unit
42 control unit
43 message board
44 terminal ID
49 terminal program
50 general use command
60 media server
62 control unit
63 image DB
64 security camera
71 time information
72 attribute information
73 addresser information.
74 addressee information.
75 body text information
81 pattern description
82 specific command generation description
83 invalidity indicator
84 proposal generation description
90 proposal information
91 proposing device ID
92 proposal text

What is claimed is:

1.-19. (canceled)

20. A controlled device,
which is connected to an access point capable of communicating wirelessly with a management terminal existing in the vicinity, comprising:
a specific function means which receives an input of a specific command, and performs a specific operation of said controlled device according to said specific command; and
an analysis means which receives a general use command, which is a command neither specifying or depending on said controlled device, from said management terminal capable of communicating with said access point, and outputs said specific command corresponding to said general use command to said specific function means.

21. The controlled device according to claim 20, wherein
if there exists said specific command corresponding to said general use command, said analysis means outputs said specific command and a response respectively to said specific function means and to said management terminal, and if there does not exist said specific command corresponding to said general use command, said analysis means ignores said general use command.

22. The controlled device according to claim 20, wherein
said analysis means receives an input of said general use command and sends proposal information including information which specifies both its own identification information and said specific operation to said management terminal, and if receiving a consent notice for said proposal information from said management terminal, said analysis means outputs said specific command to said specific function means, and if not receiving said consent notice, ignores the said general use command.

23. The controlled device according to claim 20, wherein:
said management terminal stores said general use command, and on receiving a request of sending, sends the stored said general use command; and
said analysis means sends to said management terminal said request of sending said general use command.

24. The controlled device according to claim 23, wherein
said analysis means receives from said specific function means an input of a completion notice for said specific operation corresponding to said general use command, and if the said general use command is of a specific type, said analysis means sends a request for invalidating the said general use command to said management terminal, and if the said general use command is of another type, does not send said request for invalidation.

25. The controlled device according to claim 23 wherein:
said management terminal stores said general use command with collateral information attached; and
said analysis means outputs said specific command corresponding to said general use command to said specific function means only when said collateral information satisfies a predetermined condition.

26. The controlled devices according to claim 20, comprising:
said analysis means which generates said response which includes link information for accessing output information of said specific function means; and
an information providing means which receives an input of a request designating said link information sent by said management terminal, obtains output information from said specific function means and sends the output information to said management terminal.

27. A device control system including:
said management terminal; and
a plurality of said controlled devices according to claim 1, which are each connected to any one of a plurality of said access points, of which only one is capable of communicating with said management terminal at the same time, and each of which executes a different kind of said specific operations with respect to an identical said general use command.

28. A non-transient computer-readable recording medium storing a program for controlling a controlled device, the program causing said controlled device, which is connected to an access point capable of communicating wirelessly with a management terminal existing in the vicinity, to execute:
a specific function process of receiving an input of a specific command and performing a specific operation of said controlled device according to said specific command; and
an analysis process of receiving a general use command, which is a command neither specifying or depending on said controlled device, from said management terminal capable of communicating with said access point, and generating said specific command corresponding to said general use command.

29. The non-transient computer-readable recording medium according to claim 28 storing said program for controlling said controlled device, the program causing said controlled device to execute
said analysis process wherein, if there exists said specific command corresponding to said general use command, said specific command is generated and a response is outputted to said management terminal, and if there does not exist said specific command corresponding to said general use command, the said general use command is ignored.

30. The non-transient computer-readable recording medium of according to claim 28 storing said program for controlling said controlled device, the program causing said controlled device to execute
said analysis process wherein, an input of said general use command is received, and proposal information including information specifying both said its own identification information and said specific operation is sent to said management terminal, and if a consent notice for said proposal information is received from said management terminal, said specific command is generated, and if said consent notice is not received, the said general use command is ignored.

31. The non-transient computer-readable recording medium according to claim 28, wherein:
said management terminal stores said general use command and, receiving a request for sending, sends the stored said general use command; and
said computer-readable recording medium stores said program for controlling said controlled device which causes said controlled device to execute said analysis process wherein said request for sending said general use command is sent to said management terminal.

32. The non-transient computer-readable recording medium according to claim 31 storing said program for controlling said controlled device, the program causing said controlled device to execute
said analysis process wherein, after completion of said specific operation corresponding to said general use command, if the said general use command is of a specific type, a request for invalidating the said general use command is sent to said management terminal, and if the said general use command is of another type, said request for invalidation is not sent.

33. The non-transient computer-readable recording medium according to claim 31, wherein:
said management terminal stores said general use command with collateral information attached; and
said computer-readable recording medium stores said program for controlling said controlled device which causes said controlled device to generate said specific command corresponding to said general use command only when said collateral information satisfies a predetermined condition.

34. The non-transient computer-readable recording medium according to claim 28 storing said program for controlling said controlled device, the program causing said controlled device to execute:
said analysis process of generating said response which includes link information for accessing output information of said specific operation; and
an information providing process of receiving an input of a request designating said link information sent by said management terminal, obtaining output information of said specific function process, and sending the output information to the said management terminal.

35. A method for controlling a controlled device, wherein
said controlled device, which is connected to an access point capable of communicating wirelessly with a management terminal existing in the vicinity,
receiving an input of a specific command, performs a specific operation of said controlled device according to said specific command, and
receiving a general use command, which is a command neither specifying or depending on a method for controlling a controlled device, from said management terminal capable of communicating with said access point, generating said specific command corresponding to said general use command.

36. The method for controlling said controlled device according to claim 35, wherein
said controlled device, if there exists said specific command corresponding to said general use command, generates said specific command and outputs a response to said management terminal, and if there does not exist said specific command corresponding to said general use command, ignores the said general use command.

37. The method for controlling said controlled device according to claim 35, wherein
said controlled device, receives an input of said general use command, sends proposal information including information specifying both its own identification information and said specific operation to said management terminal, and if receives a consent notice for said proposal information from said management terminal, generates said specific command, and if not receiving said consent notice, ignores the said general use command.

38. The method for controlling said controlled device according to claim 35, wherein
said management terminal stores said general use command, and on receiving a request for sending, sends the stored said general use command; and
said controlled device sends to said management terminal said request for sending said general use command.

39. The method for controlling said controlled device according to claim 38, wherein
after completion of said specific operation corresponding to said general use command, said controlled device, if the said general use command is of a specific type, sends a request for invalidating the said general use command to said management terminal, and if the said general use command is of another type, does not send said invalidation request.

40. The method for controlling a controlled device according to claim 38, wherein
said management terminal stores said general use command with collateral information attached; and
said controlled device generates said specific command corresponding to said general use command only when said collateral information satisfies a predetermined condition.

41. The method for controlling said controlled device according to claim 35, wherein
said controlled device generates said response which includes link information for accessing output information of said specific operation, and
receiving an input of a request designating said link information sent by said management terminal, obtains output information of said specific operation and sends the output information to the said management terminal.

42. A controlled device,
which is connected to an access point capable of communicating wirelessly with a management terminal existing in the vicinity, comprising:
a specific function means for receiving an input of a specific command, and performing a specific operation of said controlled device according to said specific command; and
an analysis means for receiving a general use command, which is a command neither specifying or depending on said controlled device, from said management terminal capable of communicating with said access point, and outputting said specific command corresponding to said general use command to said specific function means.
